(19) United States
(12) Patent Application Publication
(10) Pub. No.: US 2002/0181111 A1
(43) Pub. Date: Dec. 5, 2002

(54) Optical sheet

(76) Inventors: Motohiko Okabe, Wakayama (JP); Masakazu Uekita, Wakayama (JP)

Correspondence Address: MARSHALL, GERSTEIN & BORUN, 6300 SEARS TOWER, 233 SOUTH WACKER, CHICAGO, IL, 60606-6357, US

(21) Appl. No.: 10/098,813

(22) Filed: Mar. 15, 2002

(30) Foreign Application Priority Data
Mar. 19, 2001 (JP) 2001-78299
Jul. 13, 2001 (JP) 2001-213319

(51) Int. Cl. F21V 7/04

(52) U.S. Cl. 359/599; 359/707; 349/64; 362/31

(57) ABSTRACT

An optical sheet according to the present invention is an optical sheet which is capable of transmitting upwards a light beam entering the optical sheet from below and which comprises a light beam controlling section formed of first rectangular areas and second rectangular areas, each of the first rectangular areas being square or rectangle in cross section, the first rectangular areas being arranged in parallel to each other, each of the second rectangular areas being square or rectangle in cross section, the second rectangular areas being arranged in parallel to each other. The first and second rectangular areas are alternate in the lateral direction. The first rectangular area is formed of a material having a refractive index that is higher than that of a material of the second rectangular area.

This application is based on the Japanese Patent Applications Nos. 2001-78299 and 2001-213319, filed Mar. 19, 2001 and Jul. 13, 2001, respectively, the entire disclosure of which is incorporated herein by reference.

### BACKGROUND OF THE INVENTION

1. Field of the Invention

The present invention relates to an optical sheet adapted to be integrated into a backlight unit of a liquid crystal display device that is capable of transmitting upwards a light beam entering the optical sheet from below.

2. Description of the Related Art

Liquid crystal display devices have a backlight unit integrated therein which comprises a light source and a member to be used for focusing the light beams emitted from the light source onto a screen of the liquid crystal display device. More specifically, it is configured to guide the light beams emitted from the light source onto the screen of the liquid crystal display device by means of an optical waveguide that is disposed next to the light source and by means of other optical sheets.

FIG. 9 shows a schematic configuration of a conventional backlight unit 35 as an example. In FIG. 9, an arrow A represents the back-and-forth direction, an arrow B represents the right-and-left direction, and an arrow C represents the top-and-down direction. As shown in FIG. 9, the backlight unit 35 is configured with a lamp 31, an optical waveguide 32, a light diffusion sheet 33, and a prism sheet 34. The lamp 31 is used as the light source. The optical waveguide 32 is disposed in such a manner that the lamp 31 is outside the left-side end thereof. The light diffusion sheet 33 is disposed on the upper surface of the optical waveguide 32 as an optical sheet. The prism sheet 34 is disposed on the upper surface of the light diffusion sheet 33 as another optical sheet.

In this backlight unit 35, the light beams entering the optical waveguide 32 from the lamp 31 go out therethrough as light beams having a distribution with a peak in an upward direction to the right at a certain angle with respect to the upper surface of the optical waveguide 32. The light beams are then directed to the light diffusion sheet 33. The light beams entering the light diffusion sheet 33 go out through the upper surface thereof as light beams having a distribution with a peak in a direction closer to the upside because of diffusion during propagation through the light diffusion sheet 33. The light beams are then directed to the prism sheet 34 of a prism shape having an apex angle of approximately 90 degrees.

The light beams entering the prism sheet 34 go out through the upper surface of the prism sheet 34 as light beams having a distribution with a peak in a direction closer to the normal to the surface of the prism sheet 34, by prism sections 34a thereof. The light beams which came out through the upper surface of the prism sheet 34 are focused onto a screen of a liquid crystal display device (not shown) that is disposed yet above to illuminate the screen.

The prism sheet 34 has the prism sections 34a formed on the topmost portion thereof so that the light beams which came out of the prism sheet 34 can be guided to the above-mentioned target direction. The prism sheet 34 is shaped with corners of the optically-functioning prism sections 34a facing outward. There has been such a disadvantage that the corners tend to be damaged by other members.

Light diffusion capability of the light diffusion sheet 33 may be enhanced to pick up light beams closer to the normal, i.e., the direction toward the face of the screen of the liquid crystal display device. However, excessively enhanced diffusion of the light diffusion sheet 33 decreases the amount of the light to be directed to a liquid crystal screen, which disadvantageously causes reduction in efficiency relative to the light source.

In some cases, an overlaying light diffusion sheet may be used in combination with the above-mentioned prism sheet in order to protect the prism sheet. This increases the number of the members forming the backlight unit. On the other hand, recent demands toward smaller display devices for better portability require the number of the members forming the backlight unit to be reduced.

### SUMMARY OF THE INVENTION

The present invention is designed with respect to the above-mentioned problems and is directed at providing an optical sheet which is capable of guiding efficiently the light beams along a path closer to the normal direction perpendicular to a screen of a liquid crystal display device and with which it is possible to solve the problem of a possible damage of the optically-functioning parts and to reduce the number of the members forming the backlight unit.

In order to achieve the above-mentioned objects, according to an aspect of the present invention, the optical sheet comprises a light beam controlling section formed of first rectangular areas and second rectangular areas, each of the first rectangular areas being square or rectangle in cross section, the first rectangular areas being arranged in parallel to each other, each of the second rectangular areas being square or rectangle in cross section, the second rectangular areas being arranged in parallel to each other. The first and second rectangular areas are alternate in the lateral direction. The first rectangular area is formed of a material having a refractive index that is higher than that of a material of the second rectangular area.

According to the optical sheet of this invention, it is possible to transmit upwards a light beam entering the optical sheet from below while directing the light beam toward the normal, without providing prism sections having corners facing outward as can be seen in a conventional prism sheet. There is no possibility of the corners being exposed outside which otherwise often occurs in a conventional prism sheet. The problem that the optically-functioning sections tend to be damaged can be solved. In addition, no reduction of efficiency is caused with respect to the light source because the amount of the light to be directed upwards is not reduced even when the light beam is directed closer to the normal. Accordingly, it is possible to illuminate a liquid crystal screen at high efficiency with respect to the light source without increasing the number of the members forming the backlight unit.

According to another aspect of the present invention, the optical sheet comprises a light beam controlling section formed of rectangular areas and light diffusion areas, each of the rectangular areas being square or rectangle in cross section, the rectangular areas being arranged in parallel to each other, each of the light diffusion areas being square or rectangle in cross section, the light diffusion areas being arranged in parallel to each other. In the light beam controlling section, the light diffusion area is formed of beads and a binder into which the beads are dispersed. The binder is formed of a material having a refractive index that is lower than that of a material of the rectangular area. The beads and the binder are formed of materials having different refractive indexes from each other. The rectangular areas and the light diffusion areas are alternate in the lateral direction.

According to the optical sheet of this invention, the binder of the above-mentioned light diffusion areas has a refractive index that is lower than that of the rectangular areas. The light beams transmitting through the light diffusion areas may be diffused. Consequently, it is possible to transmit upwards the light beams entering the optical sheet from below while directing the light beams toward the normal. As a result, according to the optical sheet of the present invention, the light beams can efficiently be guided toward the liquid crystal screen. In addition, according to this optical sheet, the light diffusion areas can diffuse the light beams, so that projection of undesired variations of the luminance onto the screen of the liquid crystal display device can be avoided, providing a uniform luminance.

Furthermore, according to the optical sheet of the present invention, in controlling the direction of the output paths along which the light beams travel to be closer to the normal, there is no possibility of the corners being exposed outside which otherwise often occur in a conventional prism sheet. The problem that the optically-functioning sections tend to be damaged can be solved. In addition, since the optical sheet is hardly damaged, the optical sheet is advantageously easy for handling during the assembly of the backlight unit.

### BRIEF DESCRIPTION OF THE DRAWINGS

The above-mentioned objects, other objects and features of the present invention will become apparent from the following description of the preferred embodiments when considered in conjunction with the accompanying drawings in which:

FIG. 1 is a perspective view of a backlight unit according to the present invention;

FIG. 2 is a view illustrating light beams directed to an optical sheet;

FIG. 3 is a partial cross-sectional view of an optical sheet according to a first embodiment, taken along the line III-III in FIG. 1;

FIG. 4 is a partial cross-sectional view of an optical sheet according to a second embodiment;

FIG. 5 is a partial cross-sectional view of an optical sheet according to a third embodiment;

FIG. 6 is a partial cross-sectional view of an optical sheet according to a fourth embodiment;

FIG. 7 is a view illustrating steps for manufacturing optical sheets by using a sheet forming machine;

FIG. 8 is a view illustrating steps for manufacturing optical sheets; and

FIG. 9 is a perspective view of a conventional backlight unit.

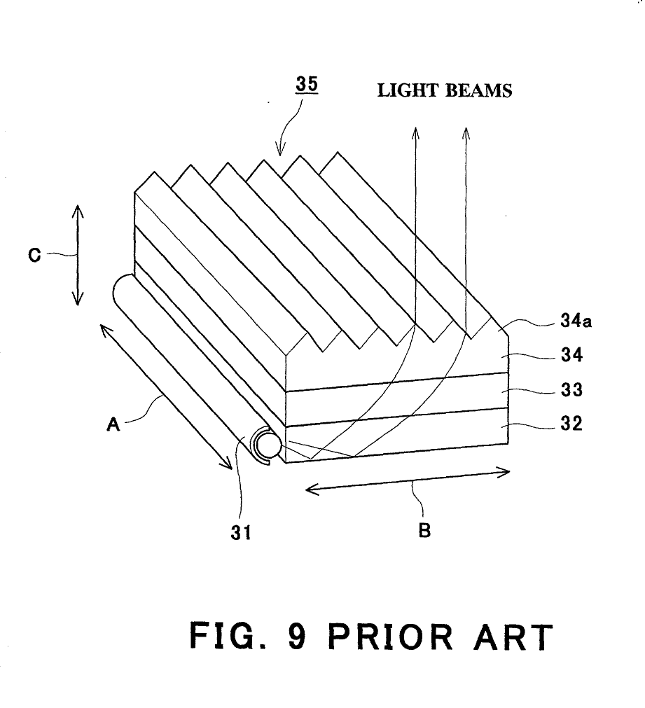

### DETAILED DESCRIPTION OF THE PREFERRED EMBODIMENTS

Next, embodiments of the present invention are described.

<First Embodiment>

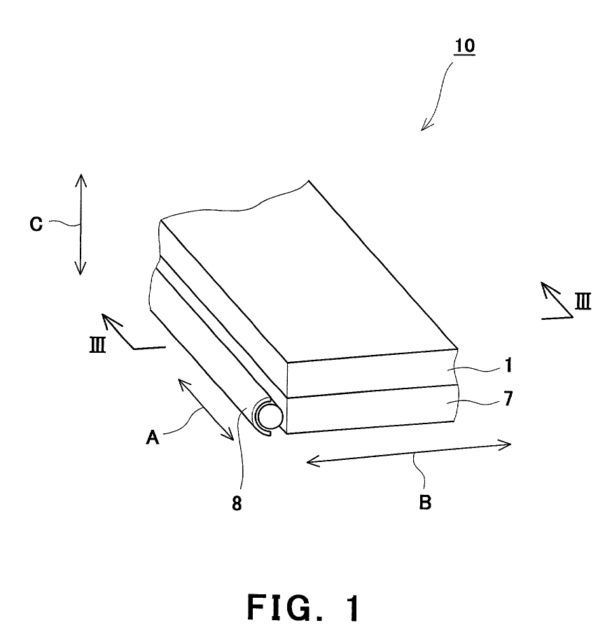

FIG. 1 is a perspective view of a backlight unit 10 in which an optical sheet 1 according to a first embodiment of the optical sheet of the present invention is used. In FIG. 1, an arrow A represents the back-and-forth direction, an arrow B represents the right-and-left direction, and an arrow C represents the top-and-down direction. The same applies to other figures attached hereto.

The backlight unit 10 is configured with a lamp 8, an optical waveguide 7, and the optical sheet 1. The lamp 8 serves as a light source in the backlight unit 10 and is disposed along the back-and-forth direction. The optical waveguide 7 is disposed in such a manner that the lamp 8 is outside the left-side end thereof. The optical waveguide 7 is a member used to guide the light beams entering the optical waveguide 7 from the left from the lamp 8 into the optical sheet 1 which will be described below. Reflective dots (not shown) or a reflective sheet is disposed on the outside of the back surface thereof. The light beams passed through the optical waveguide 7 are reflected from the reflective dots in an upward direction to the right and are directed to the optical sheet 1 through the upper surface of the optical waveguide 7.

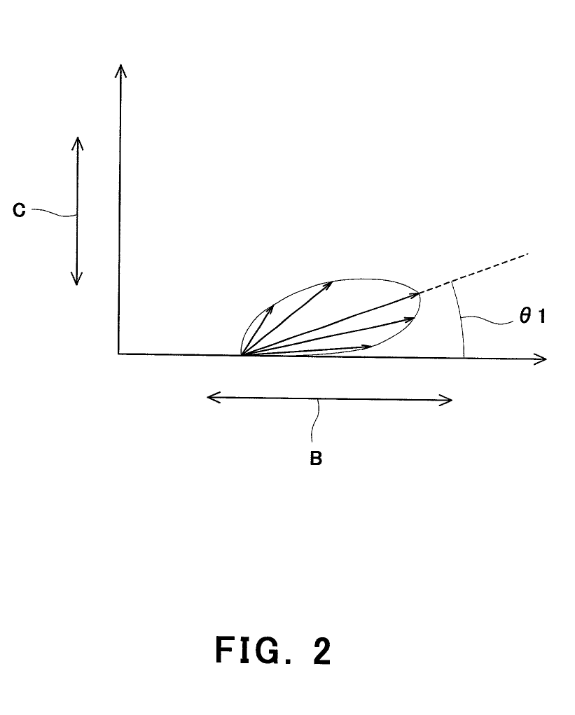

The optical waveguide 7 is formed of polymethyl methacrylate (PMMA) which is a typical material for optical waveguides. The light beams that go out through the upper surface of the optical waveguide 7 are described with reference to FIG. 2. In FIG. 2, the abscissa is placed horizontally with positive direction to the right in the right-and-left direction. The ordinate is placed vertically with positive direction up in the top-and-bottom direction. The light beams that go out through the upper surface of the optical waveguide 7 have a distribution with a peak in an upward direction to the right at a certain angle θ1 with respect to the right-and-left direction.

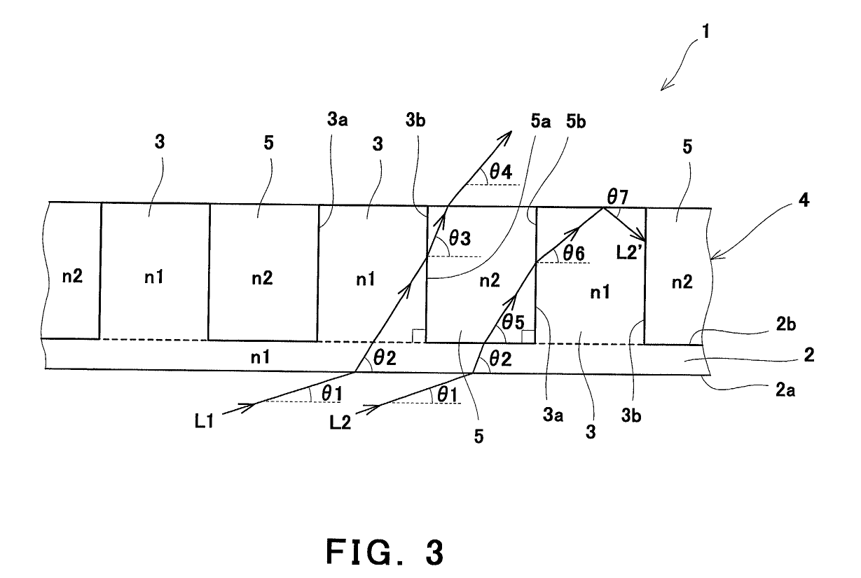

Next, the optical sheet 1 is described with reference to FIG. 3. FIG. 3 is a partial cross-sectional view of the optical sheet 1, taken along the line III-III in FIG. 1. The optical sheet 1 is disposed over the optical waveguide 7. It is a member used to guide the light beams which came out of the optical waveguide 7 onto a screen of a liquid crystal display device (not shown) that is disposed yet above.

The optical sheet 1 comprises a lower substrate section 2 and a light beam controlling section 4. The lower substrate section 2 is disposed below the light beam controlling section 4. The lower surface 2a of the lower substrate section 2 is generally planar. The light beams that exit from the optical waveguide 7 are directed into the optical sheet 1 through the lower surface 2a of the lower substrate section 2. The upper surface 2b of the lower substrate section 2 is also generally planar. The light beam controlling section 4 is fixed to the upper surface 2b of the lower substrate section 2.

The light beam controlling section 4 is formed of first rectangular areas 3 and second rectangular areas 5 that are arranged in parallel to each other. The first and second rectangular areas 3 and 5 are alternate in the lateral (right-and-left) direction. The height in the top-and-bottom direction of the first rectangular area 3 is generally equal to the height in the top-and-bottom direction of the second rectangular area 5.

The first rectangular area 3 is square or rectangle in cross section. The inner angles of the four corners forming the first rectangular area 3 are all generally ninety degrees. The first rectangular area 3 has a first side surface 3a and a second side surface 3b located on both sides. The first and second side surfaces 3a and 3b are generally perpendicular to the right-and-left direction B.

The second rectangular area 5 is square or rectangle in cross section. The inner angles of the four corners forming the second rectangular area 5 are all generally ninety degrees. The second rectangular area 5 has a first side surface 5a and a second side surface 5b located on both sides. The first and second side surfaces 5a and 5b are generally perpendicular to the right-and-left direction B.

The upper surface of the light beam controlling section 4 is formed of the upper surfaces of the first rectangular areas 3 and the upper surfaces of the second rectangular areas 5. Likewise, the lower surface of the light beam controlling section 4 is formed of the lower surfaces of the first rectangular areas 3 and the lower surfaces of the second rectangular areas 5. The upper and lower surfaces of the light beam controlling section 4 are configured in such a manner that they provide generally planar surfaces.

The lower substrate section 2, the first rectangular areas 3 and the second rectangular areas 5, which form the above-mentioned optical sheet 1, are made of a resin. Thermoplastic resins, thermosetting resins, and radiation curable resins (including ultraviolet curable resins, electron beam curable resins) may be used as the resin for forming the lower substrate section 2, the first rectangular areas 3 and the second rectangular areas 5.

Of the above-mentioned components of the optical sheet 1, the first rectangular area 3 is preferably made of a thermoplastic resin. This is because the thermoplastic resin allows easier formation of the first rectangular areas 3, when the first rectangular areas 3 are formed first during formation of the light beam controlling section 4.

On the other hand, the second rectangular area 5 is preferably made of a thermosetting resin. This is because the thermosetting resin allows easier formation of the second rectangular areas 5, when the second rectangular areas 5 are formed by means of filling the resin into the gaps between the first rectangular areas 3 that are previously made.

In forming the above-mentioned first and second rectangular areas 3 and 5, it is preferable that they be made of a radiation curable resin from the viewpoint of achieving a predetermined accuracy of shape. The radiation curable resin facilitates formation of the first and second rectangular areas 3 and 5 with predetermined accuracy.

More specific examples of the resins for forming the optical sheet 1 include acrylic resins, polycarbonates, polystyrenes, polyethylene terephthalate, polyethylene naphthalate, polyolefins, cellulose acetates, polyesters, and weather-resistant polyvinyl chloride.

As to these resins, a transparent resin is used and, it is preferable that the resin be a transparent, colorless one, because the optical sheet 1 is used to guide the light beams. In forming the optical sheet 1 by using the resin, other ingredients may be added to the resin if necessary. Examples of such ingredients include plasticizers, stabilizers, anti-deterioration agents, dispersing agents, and anti-static agents. The resin for forming the first and second rectangular areas 3 and 5 should be selected so that the first rectangular area 3 has a refractive index n1 that is higher than a refractive index n2 of the second rectangular area 5. The lower substrate section 2 is formed of the same material as the first rectangular area 3 having the refractive index of n1.

It is preferable that the materials be selected so that a difference between the refractive index n1 of the first rectangular area 3 and the refractive index n2 of the second rectangular area 5 is equal to or larger than 0.15. It is more preferable that the materials be selected so that the difference is equal to or larger than 0.3. Such selection makes it possible to guide the light beams to be closer to the normal when the light beams are directed by the light beam controlling section 4 which will be described below.

The refractive index n1 of the first rectangular area 3 is preferably equal to or higher than 1.57 and, more preferably, equal to or higher than 1.6. Such selection makes it possible to guide the light beams to be closer to the normal when the light beams are directed by the light beam controlling section 4.

As to the optical sheet 1 formed of the lower substrate section 2, the first rectangular areas 3, and the second rectangular areas 5, the top-to-down thickness thereof is defined in a range between about 50 μm and 500 μm, both inclusive. It is preferable that the top-to-down thickness of the above-mentioned optical sheet 1 be defined in a range between 70 μm and 200 μm, both inclusive.

Next, description is made with reference to FIG. 3 about how the light beams which came out of the optical waveguide 7 are guided by the optical sheet 1. In FIG. 3, the angles θ1 to θ7 defining the path of the light beams are all measured with respect to the right-to-left direction. The light beams which came out of the optical waveguide 7 have a distribution with a peak in a direction at the angle θ1 relative to the right-to-left direction, as described with reference to FIG. 2. Of the light beams traveling along this peak direction, a beam component L1 is guided as follows.

The beam component L1 enters the optical sheet 1 through the lower surface 2a of the lower substrate section 2. The beam component L1 bends toward the normal (θ1<θ2) when it strikes the surface of the lower substrate section 2. The beam component L1 propagates through the lower substrate section 2 and the first rectangular area 3. The beam component L1 then passes through the second side surface 3b of the first rectangular area 3. It then leaves the first rectangular area 3. Next, the beam component L1 enters the second rectangular area 5 through the first side surface 5a thereof. The beam component L1 bends toward the normal (θ2<θ3) when it strikes the surface of the second rectangular area 5. The beam component L1 travels through the second rectangular area 5. The beam component L1 bends away from the normal (θ4<θ3) at the upper surface of the optical sheet 1 when it leaves the optical sheet 1.

As apparent from the above, the beam component L1 enters the optical sheet 1 at the above-mentioned angle θ1 and it leaves the optical sheet 1 at the above-mentioned angle θ4. Therefore, the beam component L1 which came out of the optical waveguide 7 enters the optical sheet 1 from the bottom, and leaves upwards toward the normal (θ1<θ4).

Of the light beams which came out of the optical waveguide 7 and travel along the direction defined by the angle θ1 representing a distribution peak, a beam component L2 is guided as follows.

The beam component L2 enters the optical sheet 1 through the lower surface 2a of the lower substrate section 2. The beam component L2 bends toward the normal (θ1<θ2) when it strikes the surface of the lower substrate section 2. The beam component L2 leaves the lower substrate section 2. Next, the beam component L2 enters the second rectangular area 5. The beam component L2 bends away from the normal (θ5<θ2) when it strikes the surface of the second rectangular area 5.

The beam component L2 travels through the second rectangular area 5. The beam component L2 then passes through the second side surface 5b of the second rectangular area 5 and it leaves the second rectangular area 5. Next, the beam component L2 enters the first rectangular area 3 through the first side surface 3a thereof. The beam component L2 bends away from the normal (θ6<θ5) when it strikes the surface of the first rectangular area 3. The beam component L2 travels through the first rectangular area 3 and arrives at the upper surface of the first rectangular area 3. The beam component L2 that reaches the upper surface of the first rectangular area 3 reflects downwards as a beam component L2′ (θ7).

The beam component L2′ which arrived at the upper surface of the first rectangular area 3 and reflected downwards from the surface travels through the optical sheet 1. The beam component L2′ alternately passes through or reflects from the boundaries of the first and second rectangular areas 3 and 5. The beam components which go out the optical sheet 1 in the upward direction are closer to the normal as compared with the direction defined by the above-mentioned angle θ1. This phenomenon is achieved because of the lower substrate section 2 and the relation between the refractive index n1 of the first rectangular area 3 and the refractive index n2 of the second rectangular area 5. As apparent from the above, the beam component L2 of the incident light beam to the optical sheet 1 can also be directed to be closer to the normal.

As described above, according to the optical sheet 1, it is possible to guide the light beams having a distribution with a peak in a direction at the angle θ1, which enter the optical sheet 1 through the lower surface thereof, as the light beams having a distribution with a peak in a direction at an angle larger than the angle θ1, over the average on the entire upper surface of the optical sheet 1. It is possible to make the incident light beam go out the optical sheet 1 along the path yet closer to the normal.

The optical sheet 1 of the present invention is capable of transmitting upwards the light beam entering the optical sheet from below while directing the light beam closer to the normal when it leaves the optical sheet 1 than the incident light beam does, without providing prism sections having corners facing outward as can be seen in a conventional prism sheet. There is no possibility of the corners being exposed outside which otherwise often occur in a conventional prism sheet. The problem that the optically-functioning sections tend to be damaged can be solved.

Mutual adjustment of the refractive index n1 of the first rectangular area 3 and the refractive index n2 of the second rectangular area 5 makes it possible to control the direction along which the light beams travel when they go away from the optical sheet 1 through the upper surface thereof. This eliminates the necessity of combining additional sheet(s) such as a prism sheet with the optical sheet 1 to be used as the backlight unit. Accordingly, the backlight unit can be configured with a smaller number of members, reducing the size of the backlight unit.

In the optical sheet 1, the first and second rectangular areas 3 and 5 forming the light beam controlling section 4 are formed based on a shape contouring a square or a rectangle. Therefore, formation of them is easy when they are formed according to a method which will be described below. More specifically, in a conventional prism sheet, it was not easy to form each corner of triangles at a desired angle in order to form a triangular prism. On the contrary, the optical sheet 1 of the present invention does not involve such formation-related difficulties.

In the above-mentioned optical sheet 1, the lower substrate section 2 may be made of a different material from that of the first rectangular area 3. When the lower substrate section 2 is made of a different material from that of the first rectangular area 3, it is preferable that the lower substrate section 2 be made of a material having a refractive index that is generally equal to the refractive index of the first rectangular area 3. For example, the first rectangular area 3 may be made of a polystyrene (PS) resin having a refractive index of 1.57. The lower substrate section 2 may be made of polyethylene terephthalate (PET) having a refractive index of 1.575.

<Second Embodiment>

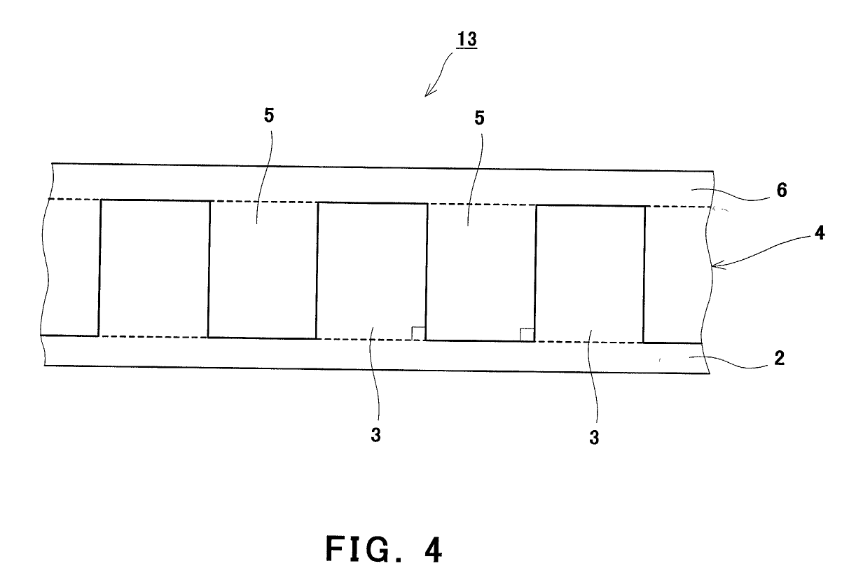

An optical sheet 13 according to a second embodiment is shown in FIG. 4. In the example of the optical sheet 1 according to the above-mentioned first embodiment, the example has thus been described where the optical sheet is formed of the light beam controlling section 4 and the lower substrate section 2. However, the optical sheet may be formed in such a manner as shown in FIG. 4. More specifically, the optical sheet may be configured with an upper substrate section 6 over the light beam controlling section 4 as in the optical sheet 13 shown in FIG. 4.

When the upper substrate section 6 is provided as in the optical sheet 13, the upper substrate section 6 may be made of the same material as that of the second rectangular area 5. Alternatively, the upper substrate section 6 may be made of a material different from that of the second rectangular area 5. In the latter case, it is more preferable that the material be selected so that the refractive index of the upper substrate section is generally equal to the refractive index of the second rectangular area 5.

In the optical sheet 13, selection of the material associated with the refractive index of the lower substrate section 2 is similar to the case of the optical sheet 1. The material may be same as or different from the material of the first rectangular area 3. When the lower substrate section 2 of the optical sheet 13 is made of a different material from that of the first rectangular area 3, it is more preferable that the material be selected so that the refractive index of the lower substrate section is generally equal to the refractive index n1.

<Third Embodiment>

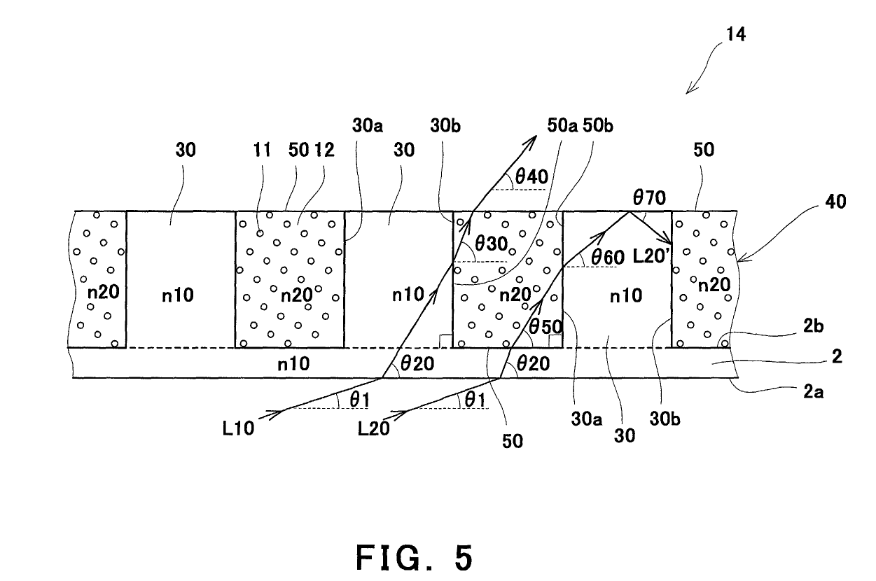

The optical sheet of the present invention may be configured as shown in FIG. 5. An optical sheet 14 according to a third embodiment is described with reference to FIG. 5. The optical sheet 14 may be used in place of the optical sheet 1 integrated into the backlight unit 10 shown in FIG. 1. FIG. 5 is a partial cross-sectional view of the optical sheet taken along the line III-III when the optical sheet 14 is used in place of the optical sheet 1 shown in FIG. 1. Similar components to those of the optical sheet 1 according to the first embodiment are depicted by similar reference numerals. The optical sheet 14 is disposed at a higher position than the above-mentioned optical waveguide 7. It is a member used to guide the light beams which came out of the optical waveguide 7 onto a screen of a liquid crystal display device (not shown) that is disposed yet above.

The optical sheet 14 comprises the lower substrate section 2 and a light beam controlling section 40. The lower substrate section 2 is disposed at a lower position than the light beam controlling section 40. The lower surface 2a of the lower substrate section 2 is generally planar. The light beams that came out of the optical waveguide 7 enter the optical sheet 14 through the lower surface 2a of the lower substrate section 2. The upper surface 2b of the lower substrate section 2 is also generally planar. The light beam controlling section 40 is fixed to the upper surface 2b of the lower substrate section 2.

The light beam controlling section 40 is formed of rectangular areas 30 and light diffusion areas 50 that are arranged in parallel to each other. The rectangular areas 30 and the light diffusion areas 50 are alternate in the lateral (right-and-left) direction. The height in the top-and-bottom direction of the rectangular area 30 is generally equal to the height in the top-and-bottom direction of the light diffusion area 50.

The upper surface of the light beam controlling section 40 is formed of the upper surfaces of the rectangular areas 30 and the upper surfaces of the light diffusion areas 50. Likewise, the lower surface of the light beam controlling section 40 is formed of the lower surfaces of the rectangular areas 30 and the lower surfaces of the light diffusion areas 50. The upper and lower surfaces of the light beam controlling section 40 are configured in such a manner that they provide generally planar surfaces.

The rectangular area 30 is square or rectangle in cross-section. The inner angles of the four corners forming the rectangular area 30 are all generally ninety degrees. The rectangular area 30 has a first side surface 30a and a second side surface 30b located on both sides. The first and second side surfaces 30a and 30b are generally perpendicular to the right-and-left direction B.

The light diffusion area 50 is square or rectangle in cross section. The inner angles of the four corners forming the light diffusion area 50 are all generally ninety degrees. The light diffusion area 50 has a first side surface 50a and a second side surface 50b located on both sides. The first and second side surfaces 50a and 50b are generally perpendicular to the right-and-left direction B.

The light diffusion area 50 is formed of beads 11, which serve as light diffusing agents, and a transparent binder resin 12 into which the beads are dispersed. Materials of the beads 11 and the binder 12 are selected so that the refractive indexes of them are different from each other. Such selection makes it possible to cause refraction of light at the boundaries between the beads 11 and the binder 12 with different refractive indexes when the light beams travel through the light diffusion area 50.

The lower substrate section 2, the rectangular areas 30 and the light diffusion areas 50, which form the above-mentioned optical sheet 14, are made of a transparent resin. Thermoplastic resins, thermosetting resins, and radiation curable resins may be used as the resin for this purpose.

In order to select the resins used for forming the rectangular areas 30 and the light diffusion areas 50, the resins are selected so that the refractive index n1 of the rectangular area 30 is higher than the refractive index n2 of the binder 12 of the light diffusion area 50. For the light diffusion area 50, the resins are selected so that the refractive index of the beads 11 is different from the refractive index of the binder 12, as described above. The lower substrate section 2 is made of the same material as the rectangular area 30. A refractive index thereof is defined as n10.

In forming the rectangular areas 30, it is preferable that a thermoplastic resin be used from the viewpoints of optical transmittance and workability. In particular, it is more preferable that the resin be a transparent, colorless one. Examples of the resin include acrylic resins, polycarbonates, polystyrenes, polyethylene terephthalate, polyethylene naphthalate, polyolefins, cellulose acetates, polyesters, and weather-resistant polyvinyl chloride.

The rectangular area 30 may be made of a radiation curable resin. With the radiation curable resin, a predetermined accuracy of shape can be achieved more easily for the formation of the rectangular areas 30. In addition, it is possible to enhance physical strength, to avoid scratches and other possible damages, and to prevent the optical properties from being changed.

As the radiation curable resin, an ultraviolet curable resin that can be cured with UV light or an electron beam curable resin that can be cured with electron beams may be used. In the present invention, any one of radiation curable resins maybe used. However, it is preferable to use the ultraviolet curable resin from the viewpoints of availability and easy handling.

The radiation curable resin is a composition obtained by means of appropriately combining reactive prepolymers, oligomers and/or monomers having a polymerizable unsaturated bind or an epoxy group in their molecules. Examples of the prepolymers and oligomers include unsaturated polyesters, which are condensation products of a polyhydric alcohol and an unsaturated dicarbonate or urethane acrylate, polyester acrylate, epoxy acrylate, and siloxane. Specific examples include acrylates such as alkyl acrylate, alkyl methacrylate, polyester acrylate, polyester methacrylate, polyether acrylate, polyether methacrylate, polyol acrylate, polyol methacrylate, melamine acrylate, and melamine methacrylate.

Examples of the monomers include vinyl benzene monomers such as styrene and α-methyl styrene, as well as methyl acrylate, methyl methacrylate, ethyl acrylate, ethyl methacrylate, butyl acrylate, butyl methacrylate, 2-ethylhexyl acrylate, 2-ethylhexyl methacrylate, methoxyethyl acrylate, methoxyethyl methacrylate, butoxyethyl acrylate, butoxyethyl methacrylate, phenyl acrylate, and phenyl methacrylate. Other examples include esters of amino alcohol and an unsaturated carboxylic acid such as N-dimethylaminoethyl acrylate, N-dimethylaminoethyl methacrylate, N-diethylaminoethyl acrylate, N-diethylaminoethyl methacrylate, N-dibenzylaminoethyl acrylate, N-dibenzylaminoethyl methacrylate, N-diethylaminopropyl acrylate, and N-diethylaminopropyl methacrylate.

Other examples include unsaturated carboxylic acid amides such as acrylamide and methacrylamide, as well as esters of glycol and an unsaturated carboxylic acid such as ethylene glycol diacrylate, ethylene glycol dimethacrylate, propylene glycol diacrylate, propylene glycol dimethacrylate, neopentyl glycol diacrylate, neopentyl glycol dimethacrylate, propylene glycol diacrylate, propylene glycol dimethacrylate, 1,6-hexanediol acrylate, 1,6-hexanediol methacrylate, triethylene glycol diacrylate, and triethylene glycol dimethacrylate.

Yet other examples include polyfunctional compounds such as dipropylene glycol diacrylate, dipropylene glycol dimethacrylate, ethylene glycol diacrylate, ethylene glycol dimethacrylate, propylene glycol diacrylate, and propylene glycol dimethacrylate, as well as polythiol compounds having two or more thiol groups in their molecules, such as trimethylolpropane trithioglycolate, trimethylolpropane trithiopropylate, and pentaerythritol tetrathioglycolate.

In order to obtain the radiation curable resin, one or more of these compounds are combined for use. A suitable radiation curable resin typically contains 5% or more by weight of a prepolymer or an oligomer and 95% or more by weight of a monomer and/or polythiol.

When an ultraviolet curable resin is selected as the radiation curable resin, a photoinitiator should be combined. As the photoinitiator, acetophenones, benzophenones, Michler's benzoyl benzoate, o-benzoyl methyl benzoate, aldoxime, tetramethylmelam monosulfide, thioxanthone and/or n-butylamine, triethylamine, and tributylphosphine, which serve as a photosensitizer, may be combined for use.

As the ultraviolet curable resin, IRGACURE 651 (Ciba-Geigy) may suitably be used in the present invention. Preferably, the ultraviolet curable resin is combined with a photoinitiator, UNIDEC 17-183 (Dainippon Ink and Chemicals, Inc.).

In forming the rectangular areas 30 by using the above-mentioned radiation curable resin, additives may be added if necessary in order to improve workability, stability in shape, and anti-static properties. Examples of such additives include plasticizers, stabilizers, anti-deterioration agents, and anti-static agents.

Taking the optical transmittance and the refractive index into consideration, a mixture of fine particles made of a single acrylic or styrene resin or of a combination of two or more of them may be used for the beads 11 forming the light diffusion areas 50. An average particle diameter is preferably between about 5 μm to about 50 μm from the viewpoint of the light diffusion properties.

For the binder 12, a thermoplastic resin may be used from the viewpoints of optical transmittance and workability. In particular, it is preferable that the resin be a transparent, colorless one. Examples thereof include acrylic resins, polycarbonates, polystyrenes, polyethylene terephthalate, polyethylene naphthalate, polyolefins, cellulose acetates, polyesters, and weather-resistant polyvinyl chloride.

It is preferable that the above-mentioned beads 11 be mixed with binder resin 12 in such a ratio that 10-300 parts by weight of beads 11 are used per 100 parts by weight of binder resin 12, when the light diffusion properties and the optical transmittance are taken into consideration.

For the above-mentioned optical sheet 14, the top-to-down thickness thereof is typically defined within a range between about 50 μm to about 500 μm, both inclusive. It is preferable that the top-to-down thickness of the above-mentioned optical sheet 1 be defined within a range between 70 μm and 200 μm, both inclusive, when use and workability are taken into consideration.

Next, description is made with reference to FIG. 5 about how the light beams which came out of the optical waveguide 7 are guided by the optical sheet 14. In FIG. 5, the angles defining the path of the light beams are all measured with respect to the right-to-left direction.

The light beams which came out of the optical waveguide 7 have a distribution with a peak in a direction at the angle θ1 relative to the right-to-left direction, as described with reference to FIG. 2. Of the light beams traveling along this peak direction, a beam component L10 is guided as follows.

The beam component L10 enters the optical sheet 14 through the lower surface 2a of the lower substrate section 2. The beam component L10 bends toward the normal (θ1<θ20) when it strikes the surface of the lower substrate section 2. The beam component L10 propagates through the lower substrate section 2 and the rectangular area 30. The beam component L10 then passes through the second side surface 30b of the rectangular area 30 and it leaves the rectangular area 30.

Next, the beam component L10 enters the light diffusion area 50 through the first side surface 50a thereof. The beam component L10 bends toward the normal when it travels from the rectangular area 30 to the light diffusion area 50 because of the difference between the refractive index n10 of the rectangular area 30 and the refractive index n20 of the binder 12. As described above, the beam component L10 is diffused when it propagates through the light diffusion area 50. The diffusion leads displacement of the peak direction of the distribution toward the normal as to the beam component L10 traveling through the light diffusion area 50.

The beam component L10 then travels through the light diffusion area 50 into an air layer over the upper surface of the optical sheet 14. The beam component L10 bends away from the normal (θ40<θ30) at the upper surface of the optical sheet 14 when it leaves the optical sheet 14 upwards because of the relation between the refractive indexes of the air layer and the light diffusion area 50.

The above-mentioned beam component L10 is the one obtained by means of bending the light beam which enters the optical sheet 14 from below, toward the normal using the optical sheet 14. More specifically, the beam component L10 goes out the optical waveguide 7, enters the optical sheet 14 from below at the above-mentioned angle of θ1, and travels upwards at the above-mentioned angle θ40 (θ40>θ1) away from the optical sheet 14.

On the other hand, a beam component L20 bends at the angle of θ20 (θ1<θ20) when it strikes the lower surface 2a of the lower substrate section 2. The beam component L20 then leaves the lower substrate section 2 and it enters the light diffusion area 50. The beam component L20 bends away from the normal (θ50<θ20) when it strikes the surface of the light diffusion area 50.

The beam component L20 travels through the light diffusion area 50. The beam component L20 then passes through the second side surface 50b of the light diffusion area 50 and it leaves the light diffusion area 50. Next, the beam component L20 enters the rectangular area 30 through the first side surface 30a thereof. The beam component L20 bends away from the normal (θ60<θ50) when it strikes the surface of the rectangular area 30.

The beam component L20 travels straight through the rectangular area 30 and arrives at the upper surface of the rectangular area 30. The beam component L20 that reaches the upper surface of the rectangular area 30 reflects downwards as a beam component L20′ (θ70).

The beam component L20′ alternately passes through or reflects from the boundaries of the rectangular area 30 and the light diffusion area 50. The beam components which go out the optical sheet 14 in the upward direction are closer to the normal as compared with the incident angle θ1 into the above-mentioned optical sheet 14 because of the difference between the refractive index n10 of the rectangular area 30 and the refractive index n20 of the binder 12 of the light diffusion area 50. The beam component L20 of the incident light beam to the optical sheet 14 can also be directed to be closer to the normal.

As described above, according to the optical sheet 14, it is possible to guide the light beams having a distribution with a peak in a direction at the angle θ1, which enter the optical sheet 14 through the lower surface thereof, as the light beams having a distribution with a peak in a direction at an angle larger than the angle θ1, over the average on the entire upper surface of the optical sheet 14. It is also possible to make the incident light beam go out the optical sheet 14 along the path yet closer to the normal.

According to the optical sheet 14 of the present invention, it is possible to guide toward the normal the light beams which exit the optical waveguide 7. It is also possible to guide efficiently the light beams onto a screen of a liquid crystal display device. In addition, according to this optical sheet 14, the light diffusion area 50 can diffuse the light beams, so that projection of undesired variations of the luminance onto the screen of the liquid crystal display device can be avoided, providing a uniform luminance.

The optical sheet 14 of the present invention is capable of transmitting the light beam entering the optical sheet from below while directing the light beam closer to the normal when it leaves the optical sheet 14 than the incident light beam does, without providing prism sections having corners facing outward as can be seen in a conventional prism sheet that can control the output paths of the light beams. There is no possibility of the corners being exposed outside which otherwise often occur in a conventional prism sheet. The problem that the optically-functioning sections tend to be damaged can be solved.

Since the optical sheet 14 is hardly damaged, the optical sheet 14 is advantageously easy for handling during the assembly of the backlight unit.

According to the optical sheet 14 of the present invention, mutual adjustment of the refractive index n10 of the rectangular area 30 and the refractive index n20 of the binder 12 of the light diffusion area 50 makes it possible to control the direction along which the light beams travel when they go away from the optical sheet 14 through the upper surface thereof. This eliminates the necessity of combining additional sheet(s) such as a prism sheet with the optical sheet 14 to be used as the backlight unit. Accordingly, the backlight unit can be configured with a smaller number of members, reducing the size of the backlight unit.

It is preferable that the materials of the rectangular areas 30 and the light diffusion areas 50 be selected so that there is a large difference between the refractive index n10 of the rectangular area 30 and the refractive index n20 of the binder 12 of the light diffusion area 50. It is preferable that the difference be 0.15 or larger. This difference makes it possible to guide the light beams more efficiently toward the normal and onto a liquid crystal screen when the light beams are directed upwards by means of the light beam controlling section 40.

It is more preferable that the difference between the refractive index n10 of the rectangular area 30 and the refractive index n20 of the binder 12 of the light diffusion area 50 be equal to or larger than 0.3. Such a difference allows the light beams traveling away from the light beam controlling section 40 to approach the normal.

In addition, the refractive index n10 of the rectangular area 30 is preferably equal to or higher than 1.57. Such selection makes it possible to guide the light beams toward the normal when the light beams are directed by the light beam controlling section 40. More preferably, the refractive index n10 of the rectangular area 30 is equal to or higher than 1.60. Such selection makes it possible to guide the light beams to be closer to the normal when the light beams are directed by the light beam controlling section 40.

Provided that the rectangular area 30 has the refractive index n10 of equal to or higher than 1.60 and that there is a difference of at least 0.3 between the refractive index n10 of the rectangular area 30 and the refractive index n20 of the binder 12 of the light diffusion area 50, the light beams take a path generally perpendicular to the liquid crystal screen when the light beams are directed by the light beam controlling section 40.

According to the optical sheet 14 of the present invention, the light diffusion properties of the light diffusion areas 50 can be adjusted by means of adjusting the combination of a blending ratio of the beads 11 into the binder 12 of the light diffusion area 50 and the materials for forming the beads 11 and the binder 12. This means that the direction of the light diffusion may be slightly adjusted relative to the screen of the liquid crystal display device.

In the optical sheet 14 of the present invention, the rectangular areas 30 forming the light beam controlling section 40 are formed based on a shape contouring a square or a rectangle. Therefore, formation of them is easy when they are formed according to a method which will be described below. More specifically, in a conventional prism sheet, it was not easy to form each corner of triangles at a desired angle in order to form a triangular prism. On the contrary, the optical sheet 14 of the present invention does not involve such formation-related difficulties.

In the above-mentioned optical sheet 14, the lower substrate section 2 may be made of a different material from that of the rectangular area 30. When the lower substrate section 2 is made of a different material from that of the rectangular area 30, it is preferable that the lower substrate section 2 be made of a material having a refractive index that is generally equal to the refractive index of the rectangular area 30. For example, the rectangular area 30 may be made of a polystyrene (PS) resin having a refractive index of 1.57. The lower substrate section 2 may be made of polyethylene terephthalate (PET) having a refractive index of 1.575.

<Fourth Embodiment>

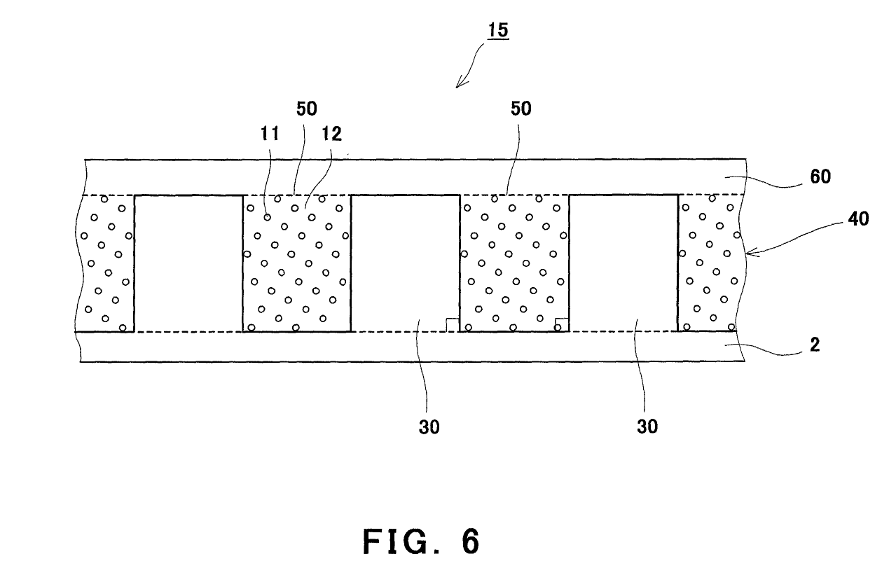

An optical sheet 15 according to a fourth embodiment is shown in FIG. 6. In the example of the optical sheet 14 according to the above-mentioned third embodiment, the example has thus been described where the optical sheet is formed of the light beam controlling section 40 and the lower substrate section 2. However, the optical sheet may be formed in such a manner as shown in FIG. 6. More specifically, the optical sheet may be configured with an upper substrate section 60 over the light beam controlling section 40 as in the optical sheet 15 shown in FIG. 6.

When the upper substrate section 60 is provided as in the optical sheet 15, the upper substrate section 60 may be made of the same material as that of the binder 12 of the light diffusion area 50. Alternatively, the upper substrate section 60 may be made of a material different from that of the binder 12 of the light diffusion area 50. In the latter case, it is more preferable that the material be selected so that the refractive index of the upper substrate section is generally equal to the refractive index of the binder 12.

In the optical sheet 15, selection of the material associated with the refractive index of the lower substrate section 2 is similar to the case of the optical sheet 14. The material may be same as or different from the material of the rectangular area 30. When the lower substrate section 2 of the optical sheet 15 is made of a different material from that of the rectangular area 30, it is more preferable that the material be selected so that the refractive index of the lower substrate section is generally equal to the refractive index n10.

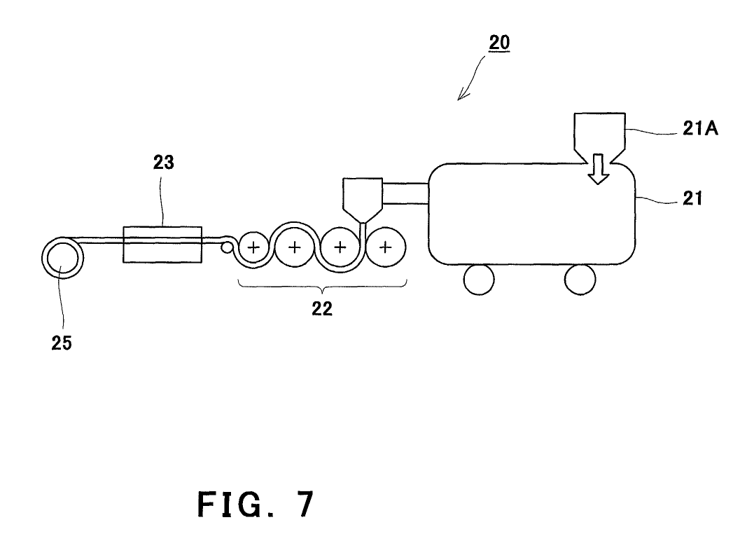

Next, a method for manufacturing optical sheets is described. This method can be applied among all optical sheets according to the first through fourth embodiments. FIG. 7 is a view schematically illustrating extrusion molding steps as an example of a method for manufacturing optical sheets. In FIG. 7, illustrated is an example where extrusion molding is performed by using a sheet forming machine.

A sheet forming machine 20 shown in FIG. 7 comprises a resin melt device 21, a forming rollers unit 22, a sheet width adjustment device 23, and a wind-up device 25. In the resin melt device 21, a resin received through an inlet 21A thereof is heated to melt at a temperature range of between 250-300° C. The forming rollers unit 22 is configured with one roller having a complementary pattern to a desired pattern and another roller which is used to nip the molten resin in cooperation with the one roller.

The sheet width adjustment device 23 is a device for cutting the sheet formed between the forming rollers to have a desired width. The wind-up device 25 is a device for winding up the resulting sheet. The sheet wound on the wind-up device 25 is pushed off the wind-up device 25 and removed from the sheet forming machine 20.

In forming the optical sheet 1 of the first embodiment by using the sheet forming machine 20, for the one roller of the forming rollers unit 22, a member is prepared that has a plurality of parallel rectangular patterns engraved in the surface thereof, in which the patterns are exactly complementary to the first rectangular areas 3. The resin for forming the first rectangular areas 3 and the lower substrate section 2 is introduced into the sheet forming machine 20 through the inlet 21A of the resin melt device 21 where the resin is molten. The molten resin is passed through the forming rollers unit 22. A sheet having the configuration of the lower substrate section 2 and the first rectangular areas 3 is thus produced.

The sheet having the configuration of the lower substrate section 2 and the first rectangular areas 3 is passed through the sheet width adjustment device 23. The sheet is then wound up on the wind-up device 25. The sheet configuring the lower substrate section 2 and the first rectangular areas 3 of the optical sheet 1 can be obtained.

Next, the second rectangular areas 5 can be formed by means of filling the gaps that are formed between the first rectangular areas 3 in the sheet obtained in the manner described above with a molten resin selected for forming the second rectangular areas 5.

Next, for the lower surface of the lower substrate section 2, a finishing process to achieve a generally planar face is performed. The finishing process is also performed in order to form the upper surfaces of the first and second rectangular areas 3 and 5 as the upper surface of the light beam controlling section 4. More specifically, the upper surfaces of the first rectangular areas 3 are exposed to the outside and are worked to have a generally planar face. In addition, the upper surfaces of the second rectangular areas 5 are subjected to the finishing process to have a generally planar face. In this way, one generally planar surface is formed of the upper surfaces of the first and second rectangular areas 3 and 5, thereby forming the upper surface of the light beam controlling section 4.

In forming the optical sheet 13 of the second embodiment by using the above-mentioned sheet forming machine 20, the second rectangular areas 5 and the upper substrate section 6 can be formed in addition to the lower substrate section 2 and the first rectangular areas 3, by means of performing similar steps to those used for forming the lower substrate section 2 and the first rectangular areas 3 of the optical sheet 1 as described above.

For the optical sheet 13, as to the shapes of the lower substrate section 2, the first rectangular areas 3, the second rectangular areas 5, and the upper substrate section 6, the second rectangular areas 5 and the upper substrate section 6 can be obtained when the lower substrate section 2 and the first rectangular areas 3 are reversed. Therefore, the second rectangular areas 5 and the upper substrate section 6 can be obtained by means of performing steps similar to those for forming the lower substrate section 2 and the first rectangular areas 3, using the resin for forming the second rectangular areas 5 and the upper substrate section 6 in place of the resin used for forming the lower substrate section 2 and the first rectangular areas 3.

After producing the sheet configuring the lower substrate section 2 and the first rectangular areas 3 as well as the sheet configuring the second rectangular areas 5 and the upper substrate section 6, these sheets are engaged with each other to obtain the optical sheet 13.

In forming the optical sheet 14 of the third embodiment by using the sheet forming machine 20, for the one roller of the forming rollers unit 22, a member is prepared that has a plurality of parallel rectangular patterns engraved in the surface thereof, in which the patterns are exactly complementary to the rectangular areas 30. The resin for forming the rectangular areas 30 and the lower substrate section 2 is introduced into the sheet forming machine 20 through the inlet 21A of the resin melt device 21 where the resin is molten. The molten resin is passed through the forming rollers unit 22. A sheet having the configuration of the lower substrate section 2 and the rectangular areas 30 is thus produced.

The sheet having the configuration of the lower substrate section 2 and the rectangular areas 30 is passed through the sheet width adjustment device 23. The sheet is then wound upon the wind-up device 25. The sheet configuring the lower substrate section 2 and the rectangular areas 30 of the optical sheet 14 can be obtained.

Next, the light diffusion areas 50 can be formed by means of filling the gaps that are formed between the rectangular areas 30 in the sheet obtained in the manner described above with the binder resin 12 in a liquid form into which the beads 11 are dispersed to form the light diffusion 50.

In filling the solution of the binder resin 12 into which the beads 11 are dispersed to form the above-mentioned light diffusion areas 50, a well-known roll coating may be used. Dispersion of the beads 11 into the binder resin 12 may be achieved by using a well-known dissolver technique.

Next, for the lower surface of the lower substrate section 2, the finishing process to achieve a generally planar face is performed. The finishing process is also performed in order to form the upper surfaces of the rectangular areas 30 and the upper surfaces of the light distribution areas 50 as the upper surface of the light beam controlling section 40. More specifically, the upper surfaces of the rectangular areas 30 are exposed to the outside and are worked to have a generally planar face. In addition, the upper surfaces of the light distribution areas 50 are subjected to the finishing process to have a generally planar face. In this way, one generally planar surface is formed of the upper surfaces of the rectangular areas 30 and the upper surfaces of the light diffusion areas 50, thereby forming the upper surface of the light beam controlling section 40.

In order to obtain the optical sheet 15 of the fourth embodiment, a resin plate used to form the upper substrate section 60 may be fixed on the upper side with respect to the light beam controlling section 40 after the optical sheet 15 is obtained through the above-mentioned steps. In fixing the upper substrate section 60 to the light beam controlling section 40, the upper substrate section 60 may be adhered to the light beam controlling section 40 using an adhesive made of a transparent resin.

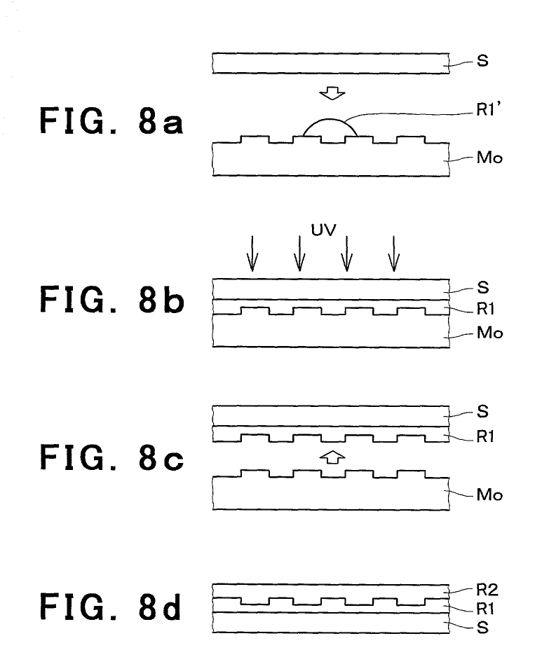

Next, an example of another method for manufacturing the optical sheet according to the present invention is described. FIG. 8 schematically shows the steps involving a technique to cure the resin with ultraviolet (UV) radiation, which is the example of the other method for manufacturing the optical sheet according to the present invention. In the following description, the optical sheet configured in the form of the optical sheet 13 of the second embodiment is described as an example, that is, the optical sheet configured with the lower substrate section 2, the first rectangular areas 3, the second rectangular areas 5, and the upper substrate section 6.

First, a mold M0 is prepared that is used to form the lower substrate section 2 and the first rectangular areas 3. The mold M0 is formed that has a plurality of parallel patterns engraved in the surface thereof. The patterns in the mold M0 are the exact complementary patterns to the first rectangular areas 3.

First, in the first step (a), an ultraviolet curable resin R1′ is supplied in the form of liquid onto the surface of the mold M0. A transparent base S, which has been prepared by using the same material as the ultraviolet curable resin, is disposed on it. Next, in the second step (b), the ultraviolet radiation UV is irradiated onto the transparent base S to cure the resin R1′, and to form a resin layer R1. Next, in the third step (c), the transparent base S and the cured resin layer R1 are both removed. In this way, the sheet configuring the lower substrate section 2 and the first rectangular areas 30 can be obtained.

Next, in the fourth step (d), for the sheet configuring the above-mentioned lower substrate 2 and the first rectangular areas 3, a resin layer R2 can be formed that corresponds to the second rectangular areas 5 and the upper substrate 6 by means of filling the gaps that are formed between the first rectangular areas 3 with the resin in the form of liquid that is selected to form the second rectangular areas 5 and the upper substrate 6.

A finishing step which is not shown is then performed. Through this step, the optical sheet 13 can be obtained. As this finishing step, for the lower surface of the lower substrate section, a finishing process is performed to achieve a generally planar face. The finishing process is also performed for the upper surface of the upper substrate section 6 to achieve a generally planar face.

Next, a more specific example of the optical sheet according to the present invention is described on the basis of the example of the optical sheet 1 of the first embodiment shown in FIG. 3. For the lower substrate section 2 and the first rectangular areas 3 of the optical sheet 1, they are formed so that the refractive index n1 is equal to 1.586. For the second rectangular areas 5, they are formed so that the refractive index n2 is equal to 1.35. In addition, it is assumed that air layers lie above and below the optical sheet 1. The refractive index n0 of the air layers is defined to be equal to 1.0.

Table 1 shows angles that represent the directions of the path in the optical sheet 1 along which the light beams are guided by the optical sheet 1, in the case where the above-mentioned components forming the optical sheet 1 have the above-mentioned refractive indexes n1 and n2. For the amounts represented by each of angles θ1 to θ7 in Table 1, the above description made with reference to FIG. 3 applies.

The angle θ1 is an angular representation between the direction of the traveling beam component L1 or L2 and the line in the right-to-left direction, along the distribution peak of the incident light beam as the beam leaves the optical waveguide 7 and goes into the optical sheet 1 through the lower surface thereof. The angle θ2 is an angular representation between the direction of the traveling beam component L1 or L2 and the line in the right-to-left direction when the light beam strikes the lower substrate section 2 and bends accordingly.

The angle θ3 is an angular representation between the direction of the traveling beam component L1 and the line in the right-to-left direction when the light beam travels from the first rectangular area 3 to the second rectangular area 5 and bends accordingly. The angle θ4 is an angular representation between the direction of the traveling beam component L1 and the line in the right-to-left direction when the light beam goes upwards away from the second rectangular area 5 and bends accordingly.

The angle θ5 is an angular representation between the direction of the traveling beam component L2 and the line in the right-to-left direction when the light beam travels from the lower substrate section to the second rectangular area 5 and bends accordingly. The angle θ6 is an angular representation between the direction of the traveling beam component L2 and the line in the right-to-left direction when the light beam travels from the second rectangular area 5 to the first rectangular area 3 and bends accordingly.

The angle θ7 is an angular representation between the line in the right-to-left direction and the direction of a beam component that reaches the upper surface of the first rectangular area 3 and reflects downwards. In this example, all beam components that reach the upper surface of the first rectangular area 3 reflect downwards.

As to the example of the optical sheet 1, polycarbonate may be used as the resin in order to form the lower substrate section 2 and the first rectangular areas 3 having the refractive index n1 of equal to 1.586. Likewise, a fluorine-containing acrylic resin may be used as the resin in order to form the second rectangular areas 5 having the refractive index n2 of equal to 1.35.

Comparison between the angles θ1 and θ4 shown in Table 1 demonstrates that, according to this optical sheet 1, the light beams received from below can be directed upwards in such a manner that the light beams are bent toward the normal. In addition, those that are reflected toward the direction defined by the above-mentioned angle θ7 can eventually be produced upwards as the light beams closer to the normal.

For the first and second rectangular areas 3 and 5, a combination shown in Table 2 may be used as to the refractive indexes n1 and n2. With respect to samples 1 and 2 in Table 2, the samples may be formed of polymethyl methacrylate (PMMA) in order to make the first rectangular areas 3 have the refractive index n1 of equal to 1.479.

With respect to samples 3 to 6, the samples may be formed of polycarbonate (PC) in order to make the first rectangular areas 3 have the refractive index n1 of equal to 1.586. With respect to samples 7 to 10, the samples may be formed of poly-p-xylene in order to make the first rectangular areas 3 have the refractive index n1 of equal to 1.669.

As to the samples 1, 4, and 10, the samples may be formed of a fluorine-containing acrylic resin in order to make the second rectangular areas 5 have the refractive index n2 of equal to 1.45. As to the samples 2 and 6, the samples may be formed of a fluorine-containing acrylic resin in order to make the second rectangular areas 5 have the refractive index n2 of equal to 1.4.

As to the samples 3 and 8, the samples may be formed of an acrylic resin in order to make the second rectangular areas 5 have the refractive index n2 of equal to 1.5. As to the sample 5, the sample may be formed of a fluorine-containing acrylic resin in order to make the second rectangular areas 5 have the refractive index n2 of equal to 1.44. As to the sample 7, the sample may be formed of a fluorine-containing acrylic resin in order to make the second rectangular areas 5 have the refractive index n2 of equal to 1.363.

In the above description, as shown in FIGS. 3 to 6, the example has thus been described where a single layer of the light beam controlling section 4 (formed of the first rectangular areas 3 and the second rectangular areas 5) or of the light beam controlling section 40 (formed of the rectangular areas 30 and the light diffusion areas 50) is provided. However, two or more layers of the light beam controlling section 4 or 40 may be laminated with each other. With a plurality of layers of the light beam controlling section 4 or 40 placed on top of the previous one, the light beams received from below can be directed upwards along the closer path to the normal.

In the above description, in order to use the optical sheet of the present invention, the example has thus been described where the optical sheet is integrated into the backlight unit having the lamp 8 disposed only on one side of the optical waveguide 7 as described with reference to FIG. 1. However, the lamp 8 that is used as the light source is not necessarily disposed only on one side of the optical waveguide 7.

More specifically, in order to use the optical sheet of the present invention, another lamp 8 may be disposed on the right side of the optical waveguide 7 when viewed based on the configuration of the optical waveguide 7 and the optical sheet 1 shown in FIG. 1. As apparent from the above, even when the lamps are disposed on both sides of the optical waveguide 7, it is possible to guide upwards the light beams toward the normal that are emitted from the two lamps into the optical sheet from below through the optical waveguide 7.

In addition, with respect to the optical sheets described above, alight diffusion layer which is not shown specifically may be provided on the topmost layer. For the light diffusion layer, it may be formed by any one of various known light diffusion layers. A well-known configuration may be used as the light diffusion layer such as those formed of beads and a binder or those having an embossed surface on a light beam emitting side.

Using the light diffusion layer provided on the optical sheet of the present invention, the peak direction of the light beam can be laid closer to the normal because of diffusion of light produced by the light diffusion layer when the light beam travels upwards away from the light diffusion layer. Therefore, the light beams can take the path much closer to the normal as compared with those achieved with a conventional light diffusion sheet. The light beams can be guided efficiently onto a screen of a liquid crystal display device without increasing the number of the members forming the backlight unit.

Furthermore, as to the optical sheets as described above, an anti-sticking layer which is not shown specifically may be provided on the lowermost layer. The anti-sticking layer may be formed by a known anti-sticking layer. The anti-sticking layer may be formed by means of providing it on the lowermost layer in such a manner that the anti-sticking layer projects below beads which are separated from each other. Using this anti-sticking layer, the optical sheet is adjacent to the optical waveguide with the in-between anti-sticking layer when the backlight unit is assembled. This prevents any projection of glittering light images on a liquid crystal screen.

TABLE 1

| | |
|---|---|
| θ1 | 15° |
| θ2 | 52.479° |
| θ3 | 68.711° |
| θ4 | 60.65° |
| θ5 | 45.686° |
| θ6 | 36.487° |
| θ7 | REFLECT DOWNWARDS |

TABLE 2

| | n1 | n2 |
|---|---|---|
| SAMPLE 1 | 1.479 | 1.45 |
| SAMPLE 2 | 1.479 | 1.4 |
| SAMPLE 3 | 1.586 | 1.5 |
| SAMPLE 4 | 1.586 | 1.45 |
| SAMPLE 5 | 1.586 | 1.44 |
| SAMPLE 6 | 1.586 | 1.4 |
| SAMPLE 7 | 1.669 | 1.363 |
| SAMPLE 8 | 1.669 | 1.5 |
| SAMPLE 9 | 1.669 | 1.479 |
| SAMPLE 10 | 1.669 | 1.45 |

What is claimed is:

1. An optical sheet capable of transmitting upwards a light beam entering the optical sheet from below, said optical sheet comprising:
a light beam controlling section formed of first rectangular areas and second rectangular areas, each of the first rectangular areas being square or rectangle in cross section, the first rectangular areas being arranged in parallel to each other, each of the second rectangular areas being square or rectangle in cross section, the second rectangular areas being arranged in parallel to each other,
in said light beam controlling section, the first and second rectangular areas being alternate in the lateral direction, the first rectangular area being formed of a material having a refractive index that is higher than that of a material of the second rectangular area.

2. An optical sheet as claimed in claim 1, wherein the height of the first rectangular area is equal to the height of the second rectangular area, and wherein an upper surface of said light beam controlling section and a lower surface of said light beam controlling section are both generally planar, the upper surface of said light beam controlling section being formed of the upper surfaces of the first and second rectangular areas, and the lower surface of said light beam controlling section being formed of the lower surfaces of the first and second rectangular areas.

3. An optical sheet as claimed in claim 1, wherein a difference in refractive index between the first rectangular area and the second rectangular area is equal to or larger than 0.15.

4. An optical sheet as claimed in claim 3, wherein the difference in refractive index between the first rectangular area and the second rectangular area is equal to or larger than 0.3.

5. An optical sheet as claimed in claim 1, wherein the refractive index of the first rectangular area is equal to or higher than 1.57.

6. An optical sheet as claimed in claim 5, wherein the refractive index of the first rectangular area is equal to or higher than 1.6.

7. An optical sheet as claimed in claim 1, further comprising a light diffusion layer provided on the topmost layer.

8. An optical sheet as claimed in claim 1, further comprising an anti-sticking layer provided on the lowermost layer.

9. An optical sheet capable of transmitting upwards a light beam entering the optical sheet from below, said optical sheet comprising:
a light beam controlling section formed of rectangular areas and light diffusion areas, each of the rectangular areas being square or rectangle in cross section, the rectangular areas being arranged in parallel to each other, each of the light diffusion areas being square or rectangle in cross section, the light diffusion areas being arranged in parallel to each other,
in said light beam controlling section, the light diffusion area being formed of beads and a binder into which the beads are dispersed, the binder being formed of a material having a refractive index that is lower than that of a material of the rectangular area, the beads and the binder being formed of materials having different refractive indexes from each other, the rectangular areas and the light diffusion areas being alternate in the lateral direction,

10. An optical sheet as claimed in claim 9, wherein the height of the rectangular area is equal to the height of the light diffusion area, and wherein an upper surface of said light beam controlling section and a lower surface of said light beam controlling section are both generally planar, the upper surface of said light beam controlling section being formed of the upper surfaces of the rectangular areas and the upper surfaces of the light diffusion areas, and the lower surface of said light beam controlling section being formed of the lower surfaces of the rectangular areas and the lower surfaces of the light diffusion areas.

11. An optical sheet as claimed in claim 9, wherein a difference in refractive index between the rectangular area and the binder of the light diffusion area is equal to or larger than 0.15.

12. An optical sheet as claimed in claim 11, wherein the difference in refractive index between the rectangular area and the binder of the light diffusion area is equal to or larger than 0.3.

13. An optical sheet as claimed in claim 9, wherein the refractive index of the rectangular area is equal to or higher than 1.57.

14. An optical sheet as claimed in claim 13, wherein the refractive index of the rectangular area is equal to or higher than 1.6.

15. An optical sheet as claimed in claim 9, further comprising a light diffusion layer provided on the topmost layer.

16. An optical sheet as claimed in claim 9, further comprising an anti-sticking layer provided on the lowermost layer.
